(19) United States
(12) Patent Application Publication
(10) Pub. No.: US 2021/0344975 A1
(43) Pub. Date: Nov. 4, 2021

(54) CONTENT SHARING METHOD, CONTENT MANAGEMENT PLATFORM THEREFOR, AND RECORDING MEDIUM FOR STORING APPLICATION EXECUTING THE METHOD

(71) Applicant: SK STOA CO., LTD., Seoul (KR)

(72) Inventor: Dae Ho MYOUNG, Seoul (KR)

(73) Assignee: SK STOA CO., LTD., Seoul (KR)

(21) Appl. No.: 17/307,566

(22) Filed: May 4, 2021

(30) Foreign Application Priority Data
May 4, 2020 (KR) 10-2020-0053383

(51) Int. Cl. H04N 21/239

(52) U.S. Cl. CPC H04N 21/239

(57) ABSTRACT

A content sharing method includes receiving an upload request of content from a registered member company, converting the content to correspond to a platform standard of a distributor, uploading the converted content to a content sharing service, transmitting the converted content to the distributor through the content sharing service, and updating a content list based on data related to the content.

### CROSS-REFERENCE TO RELATED APPLICATION

This application is based on and claims priority under 35 U.S.C. § 119 to Korean Patent Application No. 10-2020-0053383, filed on May 4, 2020, in the Korean Intellectual Property Office, the disclosure of which is incorporated by reference herein in its entirety.

### BACKGROUND

### 1. Field

Embodiments of the present disclosure relate to a content management platform system and a content sharing method using the content management platform system. Specifically, the present disclosure relates to a platform for managing content uploaded by each of a plurality of cooperative companies and a content sharing method using the platform for managing content.

### 2. Description of the Related Art

An Internet Protocol television (IPTV) service provider may provide various services to IPTV service subscribers through a set-top box installed in a designated space such as a home. An example of such an IPTV service provided to subscribers may be a shopping broadcasting service (or commerce broadcasting) provided through a commerce channel. In the case of a commerce business operator producing such a shopping broadcasting service, a certain amount is paid to the IPTV service provider, and a shopping broadcasting service to be broadcast on a channel assigned/scheduled accordingly is organized. When the IPTV service subscriber selects the promised channel in the set-top box, the set-top box receives the shopping broadcasting service regularly arranged on the channel and outputs the shopping broadcasting service through the TV connected to the set-top box, so that IPTV service subscribers can use the shopping broadcasting service.

Currently, for contents serviced in the form of video on demand (VOD), other than contents serviced in the form of real-time broadcasting among shopping broadcasting services, there is a lack of additional service functions to increase customer convenience and reliability. In addition, since platforms of the IPTV service, to which the customer subscribes, vary, there may be a lack of technical support as commerce operators provide shopping broadcasting services through various IPTV service platforms.

### SUMMARY

The present disclosure provides a system and method for easily sharing content not only for broadcasters but also for cooperative companies in order to solve the above-described problems.

Additional aspects will be set forth in part in the description which follows and, in part, will be apparent from the description, or may be learned by practice of the presented embodiments of the disclosure.

Embodiments of the present disclosure relate to a content sharing method, a content management platform system, and a recording medium. According to embodiments of the present disclosure, a content sharing method of a content management server includes: receiving an upload request of selected content from a registered member system; converting, with a content management server having a database and a controller, the selected content to a first converted content to correspond to a first platform standard of a first distributor system; uploading the first converted content to a content sharing service application; converting, with a content management server, the selected content to a second converted content to correspond to a second platform standard of a second distributor system; uploading the second converted content to the content sharing service application; transmitting the first converted content to the first distributor system through the content sharing service application; and transmitting the second converted content to the second distributor system through the content sharing service application.

In at least one variant, the content sharing method may further comprise updating a content list based on a set of data relevant to the content.

In another variant, converting the selected content may include generating metadata based on the set of data relevant to the content, adding the metadata to the first and second converted contents, and storing the metadata-added first and second converted contents in the database.

In further another variant, the set of data relevant to the content may include a content name, a content category, a PD (producer) name, a show host name, a product code, or a combination thereof.

In further another variant, the method may further include when content included in the content list is displayed on a user terminal through the platform of the first distributor system or the second distributor system, receiving additional information corresponding to a display on the user terminal, and updating the content list based on the additional information.

The additional information may include a cumulative number of views, a cumulative sales amount, a purchase connection rate compared to the number of views, a rating, a review from the user terminal, or a combination thereof.

According to another aspect of the present disclosure, provided is a computer-readable recording medium on which a program for performing the methods is recorded.

According to another aspect of the present disclosure, a content management platform system includes: a platform manager configured to receive an upload request of selected content from a registered member system, convert the selected content to a first converted content to correspond to a first platform standard of a first distributor system, convert the selected content to a second converted content to correspond to a second platform standard of a second distributor system, upload the first converted content to a content sharing service application, and upload the second converted content to the content sharing service application; and a content providing controller configured to transmit the converted content to the distributor system through the content sharing service application.

In at least one variant, the platform manager may update a content list based on a set of data related to the content.

In another variant, the platform manager may generate metadata based on the set of data related to the content, add and store the metadata to the selected content, and convert the selected content to correspond to a platform standard of the distributor system.

In further another variant, the data related to the content may include a content name, a content category, a PD name, a show host name, a product code, or a combination thereof.

In further another variant, when content included in the contents list is displayed on a user terminal through the platform of the first distributor system or the second distributor system, the platform manager may obtain additional information corresponding to a display on the user terminal and update the content list based on the additional information.

The additional information may include a cumulative number of views, a cumulative sales amount, a purchase connection rate compared to the number of views, a rating, a review from the user terminal, or a combination thereof.

In another variant, the content providing controller is further configured to control a display of a channel on a user terminal such that the content providing controller transmits, base information and functions in response to a channel selection on the user terminal, a set-top box connected to the user terminal. First content according to the base information and functions is received from the first distributor system or the second distribution system and displayed on the user internal along with second content provided by the content providing controller on the user terminal.

In further another variant, the content providing controller is further configured to control a display of video and image information on a user terminal such that in response to a channel selection on the user terminal, the content providing controller transmits a channel image corresponding to the channel selection, controls a display of information from the distributor system and a display for a user's selection input and response, controls a display of a frame in the form of a fixed image for a predetermined period of time, and control a display position of the video and image information.

In further another variant, the content providing controller further includes a database configured to store contents and correlated metadata uploaded through the content sharing service application, image information, and applications for executing a main channel image upon selection of a channel at a user terminal communicatively connected to the content management platform system and an application image displayed on the user terminal.

A content sharing method according to one or more embodiments of the present disclosure includes receiving first content from a first registered member system, transcoding, with a content management server having a database and a controller, the first content according to a first platform specific standard used for use in a first broadcast server, storing in the memory and uploading, transcoded first content using a content sharing service application, generating a transformed copy of the transcoded first content with the content management server according to a second platform specific standard for use with a second broadcaster server, storing in the memory and uploading the transformed copy of the transcoded first content using the content sharing service application, transmitting the transcoded first content to the first broadcaster server through the content sharing service application, and transmitting the transformed copy of the transcoded first content to the second broadcast server through the content sharing service application.

In at least one variant, the content sharing method further includes transmitting the transcoded first content further comprises transmitting an URL of the transcoded first content and the correlated metadata to the first broadcast server.

In another variant, the content sharing method further includes transmitting the transformed copy to a set-top box communicatively coupled to the second broadcast server.

In further another variant, the content sharing method further includes updating a content list based on uploaded contents and correlated metadata, wherein the content list includes a list of a plurality of contents uploaded by a plurality of registered member systems.

In another variant, the content sharing method further includes upon receiving a first user input for selecting one of the content list through the content sharing service application, transmitting, with the content management server, first additional information corresponding to the first user input, to one of the broadcast servers associated with the selected list.

In another variant, the content sharing method further includes upon receiving a second user input for selecting another of the content list through the content sharing service application, transmitting, with the content management server, second additional information corresponding to the second user input, to a user terminal through the content sharing service application.

Other aspects, features, and advantages other than those described above will become apparent from the following drawings, claims, and detailed description of the invention.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a system diagram showing a platform system according to an embodiment of the present disclosure;

FIG. 2 is a simple block diagram for explaining the components constituting a content management server according to an embodiment of the present disclosure;

FIG. 3 is a simple flowchart illustrating a method of managing content by using a content sharing service through a content management server according to an embodiment of the present disclosure;

FIG. 4 is a diagram illustrating a content sharing service UI according to an embodiment of the present disclosure;

FIG. 5 is a diagram for a content list displayed on a content sharing service according to an embodiment of the present disclosure;

FIGS. 6A to 6C are diagrams for explaining that additional information for each PD (producer), MD (merchandiser), and show host is displayed on a member company account according to an embodiment of the present disclosure, where:

FIG. 6A illustrates one example of additional information list upon selection of a “PD” menu;

FIG. 6B illustrates another example of additional information list upon selection of a “MD” menu; and

FIG. 6C illustrates further another example of additional information list upon selection of a “show host” menu; and

FIGS. 7A and 7B are diagrams for explaining that additional information for each classification (or category) is displayed on a member company account and a user account, respectively, where:

FIG. 7A illustrates a display of additional information for each classification on a member system upon selection of a GUI menu; and

FIG. 7B illustrates another display of additional information on the member system upon selection of another GUI menu.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Since the present disclosure may apply various modifications and have various embodiments, specific embodiments are illustrated with reference to the drawings and will be described in detail. Effects and features of the present disclosure, and a method of achieving them will be apparent with reference to the embodiments described below in detail together with the drawings. However, the present disclosure is not limited to the embodiments disclosed below and may be implemented in various forms.

Hereinafter, embodiments of the present disclosure will be described in detail with reference to the accompanying drawings, and when describing with reference to the drawings, the same or corresponding constituent elements are given the same reference numerals, and redundant descriptions thereof will be omitted.

In the following embodiments, terms such as first and second are not used in a limiting meaning, but for the purpose of distinguishing one component from another component.

In the following examples, the singular expression includes the plural expression unless the context clearly indicates otherwise.

In the following embodiments, terms such as include or have means that the features or elements described in the specification are present, and do not preclude the possibility of adding one or more other features or elements in advance.

The following description refers to the accompanying drawings, which illustrate specific embodiments in which the present disclosure may be implemented. These embodiments are described in detail sufficient to enable a person skilled in the art to practice the present disclosure. It should be understood that the various embodiments of the present disclosure are different from each other, but need not be mutually exclusive.

In addition, it should be understood that the location or arrangement of individual elements in each embodiment may be changed without departing from the spirit and scope of the present disclosure. Accordingly, the detailed description to be described below is not made in a limiting sense, and the scope of the present disclosure should be taken as encompassing the scope claimed by the claims of the claims and all scopes equivalent thereto. Like reference numerals in the drawings indicate the same or similar elements over several aspects.

Hereinafter, various embodiments of the present disclosure will be described in detail with reference to the accompanying drawings in order to enable those of ordinary skill in the art to easily implement the present disclosure.

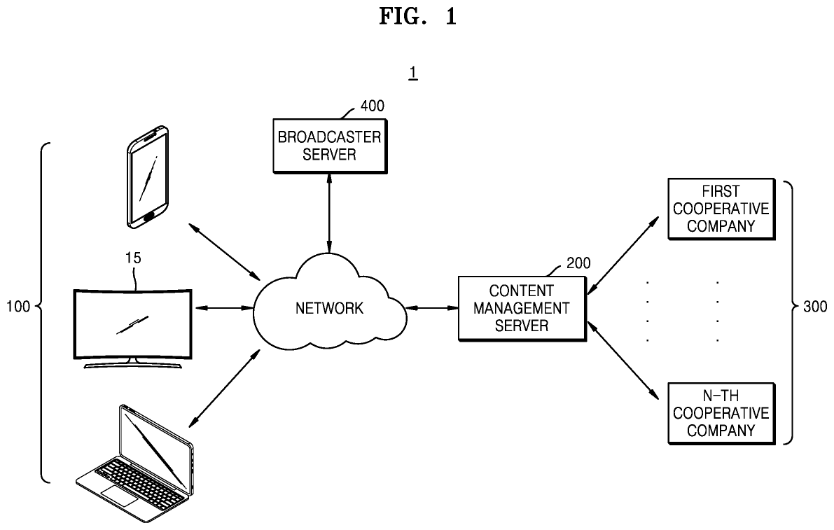

FIG. 1 is a system diagram showing a platform system according to an embodiment of the present disclosure.

Referring to FIG. 1, the platform system 1 of the present disclosure may include a content management server 200. The content management server 200 may exchange data with a group of member companies 300 and may also be connected to a broadcaster server 400 through a network. The group of member companies 300 here indicate computing systems and devices for use with the member companies 300.

A user terminal 100, the content management server 200, and the broadcaster server 400 may communicate with one another through a network, and the content management server 200 and the member company group 300 may also transmit and receive data to and from each other through a network or the like. The communication method of the network of the present disclosure is not limited, but the network according to some embodiments may use short-range wireless communication.

In the present disclosure, the user terminal 100 may include any type of electronic device having a display such as a smart TV, a smart phone, and a personal media player (PMP). On the other hand, when the user terminal 100 is implemented as a portable device, it may have a built-in touch screen and may be implemented to execute a program using a finger or a pen (e.g., a stylus pen).

FIG. 1 is only by way of example, and the user terminal 100 according to another embodiment may include a set-top box (not shown) connected to a TV 15. The user of the user terminal 100 may communicate directly with the TV 15 or with a set-top box connected to the TV 15 using a remote control device (e.g., a remote controller). Hereinafter, it is assumed that the user terminal 100 is the TV 15 for convenience of description.

The user terminal 100 may be installed in a designated space such as a user's home to provide an Internet Protocol television (IPTV) service, and may receive data on an IPTV service such as a shopping broadcasting service provided through a commerce channel using a set-top box and provide a related image or video to a user.

The TV 110 may display, through the set-top box 100, a channel image corresponding to the information received from the broadcaster server 400 and an application image corresponding to the information received from the content providing server 200 through the set-top box 100. In addition, the user terminal 100 may receive a user input through a remote control device such as a remote controller, and transmit a user input signal to the content management server 200 in response thereto. Alternatively, a set-top box connected to the user terminal 100 may receive a user input through a remote control device such as a remote controller, and transmit a user input signal to the content management server 200 in response thereto.

The content management server 200 may communicate with the user terminal 100 or a set-top box connected to the user terminal 100 through a network. In addition, the content management server 200 may communicate with the broadcaster server 400 through a network. The content management server 200 may transmit content information corresponding to the application image to the user terminal 100 or a set-top box connected to the user terminal 100.

The content management server 200 may enable the application image to be driven on the screen of the user terminal 100 through a set-top box using a cloud service. In some forms, the content management server 200 may drive an application stored in a cloud server, and allow each user terminal 100 to display an image corresponding to the application through a set-top box.

Specifically, the content management server 200 may display capture information of such content on the screen of the user terminal 100, through the set-top box, instead of the information itself containing various contents such as operations through a cloud solution. As such a cloud solution, application execution with the content management server 200 may be performed in various browsers or various software execution platforms, and for example, may be executed in a Chrome browser.

Accordingly, it is possible to solve the problem of an overload or a need for a high-end device in the user terminal 100 or a set-top box (not shown).

Additionally or alternatively, while the “main channel image” is displayed on the screen of the user terminal 100 through the user's channel selection, the content management server 200 may be connected to the user terminal 100 or the set-top box connected to the user terminal 100. When the user selects a channel, the content management server 200 transmits video information (e.g., video link information) and/or other various information or functions from the broadcaster server 400 to the set-top box connected to the user terminal 100. The set-top box uses such information to receive video data from the broadcaster server 400, so that an image from the broadcaster server 400 together with the screen information provided from the content management server 200 may be implemented on the screen of the user terminal 100 connected to the set-top box.

In some forms, the content management server 200 may control conversion of a first cloud server (not shown) and a second cloud server (not shown) having different types when implementing an application using a cloud server.

For example, the first cloud server may have thousands of users (e.g., 3,000 to 6,000 users) for each open window (application), and may accommodate tens of times more (e.g., 10 to 30 times) than the second cloud server. However, through the first cloud server, each user sees the same image on a TV screen.

The second cloud server may be accessed by a small number of users, as a specific example, one user per one opened window (application), and in this case, approximately hundreds of people (e.g., about 300 people) may be accommodated per server.

Server resources may be consumed largely because of the constant encoding and capturing of each and every window screen.

The content management server 200 may implement a screen in the user terminal 100 connected to the set-top box by running an application corresponding to the selected channel through the first cloud server, and then the first cloud server may implement a screen on the user terminals 100 of a plurality of users. Then, if a user takes an action, such as manipulating a remote controller, etc., in the case of the set-top box connected to the user terminal 100 of the user, the connection may be changed to be connected to the second cloud server. If users mainly watch the first screen broadcast when changing channels and do not use a remote controller, connection to the second cloud server may be avoided and the efficiency of running an application through the cloud server may be effectively improved for all users.

The content management server 200 may control a delivery process of one or more pieces of information through application execution. For example, information of each of the videos displayed on the user's screen through application operation, shopping deal information included in the video, sales item information included in the shopping deal, and the execution time and remaining time information when the video is executed, may be handled by the content management server 200, and this information may be transmitted to the user terminal 100 through the set-top box to be displayed in various forms on the screen.

In addition, when the user performs one or more actions by viewing the screen of the user terminal 100, for example, the user performs a selection for the UI, the content management server 200 may receive from the set-top box that there has been such a selection, and use or store the related information, or transmit the related information to a management server or the like through a network.

When specific commerce content is registered by the broadcaster server 400 or the member company 300, the content management server 200 may convert and process the specific commerce content based on metadata of the specific commerce content according to the platform standard of each distributor for distribution of specific commerce content. The distributor here indicates computing systems and devices for use with the distributor.

The distributor may be the broadcaster server 400 that provides a broadcasting service or an IPTV service to a user through a set-top box, and the platform standard of each distributor may be a specification or a requirement for a content format such that the distributor can provide the user with the content through its specific platform.

The content management server 200 may further realize a platform support function of distributing, to a platform of each distributor, the specific commerce content converted according to a platform standard for each distributor. Particularly, when specific commerce content and meta information are obtained, the content management server 200 may convert and process (transcode) specific commerce content according to the platform standard for each distributor, and when the inspection of specific commerce content and meta information are completed, the content management server 200 may batch-distribute specific commerce content converted to match the platform standard for each distributor to the platform of each distributor.

The member company 300 may be engaged in a commerce business that has a cooperative relationship, such as a specific contract with the operating entity of the content management server 200 and/or the broadcaster server 400. The member company 300 may include plurality (e.g., a first member company to an n-th member company). In the present disclosure, the member company 300 is described for convenience of explanation, but may be a server of a commerce business or a terminal device of a commerce operator. In this case, the commerce operator terminal device may be any type of electronic device having a display such as a PC, a laptop computer, and a smart phone. Hereinafter, for convenience, it is assumed and described that the member company 300 is a commerce operator terminal device.

The broadcaster server 400 according to an embodiment of the present disclosure may transmit the main channel image data to the set-top box through a network, and transmit the main channel image to the user terminal 100 connected to the set-top box. Channel images transmitted from the broadcaster server 400 to each user terminal 100 may be independent and different. That is, the channel image transmitted from the broadcaster server 400 to the set-top box connected to the user terminal 100 may be different from the channel image transmitted from the broadcaster server 400 to a set-top box connected to another user terminal 100. Of course, in some cases, the channel image transmitted from the broadcaster server 400 to the set-top box connected to the user terminal 100 may be the same or similar to the channel image transmitted from the broadcaster server 400 to a set-top box connected to another user terminal 100.

The user terminal 100 may perform network communication with the content management server 200 using a platform for each distributor through a set-top box. In this case, the distributor may be a broadcaster server 400 providing IPTV service to each user terminal 100 and/or set-top box, and the distributor platform may be a platform according to a standard corresponding to a viewing environment through each broadcaster server 400.

In some forms, when a specific UI is selected by the user terminal 100 or a set-top box connected thereto, the content management server 200 may provide additional information on the corresponding UI through the platform of each distributor. As one example, when the user terminal 100 playing commerce content receives information indicating that the UI according to the manipulation of the remote controller is selected through the set-top box, the content management server 200 may transmit the rating information collected for the commerce content being played to the set-top box so that the rating information is displayed in a pop-up form in the user terminal 100 connected to the set-top box. For this, the content management server 200 according to the present disclosure may collect/manage rating information for each commerce content through various collection types. The above-described example is only an example, and additional embodiments will be described in the related drawings.

According to an embodiment of the present disclosure, the member company 300 may perform network communication with the content management server 200 via a content management web through a content sharing service.

Specifically, the content management server 200 may manage a content sharing service for each of the plurality of member companies 300 to upload commerce content. In this case, the content sharing service may be a web-based solution or a set of interfaces that are open to share content. At least one of the member companies 300 may register corresponding commerce content and metadata for the corresponding commerce content through the content sharing service.

When the member company 300 uploads the first content and its metadata through the content sharing service, the content management server 200 may transcode the first content and metadata according to each of platform-specific standards of the distributors and then propagate the transcoded content and metadata to corresponding one of distributors. For example, the content management server 200 may transcode the first content and metadata to a first converted content to correspond to a first platform standard of a first distributor and propagate the first converted content to the first distributor, and may transcode the first content and metadata to a second converted content to correspond to a second platform standard of a second distributor and propagate the second converted content to the second distributor.

In other words, even though the member company 300 does not upload its content to each of the distributors but uploads its content only to the content management server 200, each distributor may utilize content originated from the first content converted by and provided from the content management server 200. The user terminal 100 and/or the set-top box may access and view the first content through any distributor.

Alternatively, when a specific UI is selected from the content sharing service, the content management server 200 may provide additional information on the corresponding UI from the content sharing service.

For example, when a specific UI is selected in the content sharing service of the member company 300, the content management server 200 according to the present disclosure may display additional information corresponding to the corresponding UI in the form of a list. The content management server 200 according to the present disclosure may collect/manage information for elements corresponding to each UI through various collection types. The above-described example is only by way of example, and additional embodiments will be described in the related drawings.

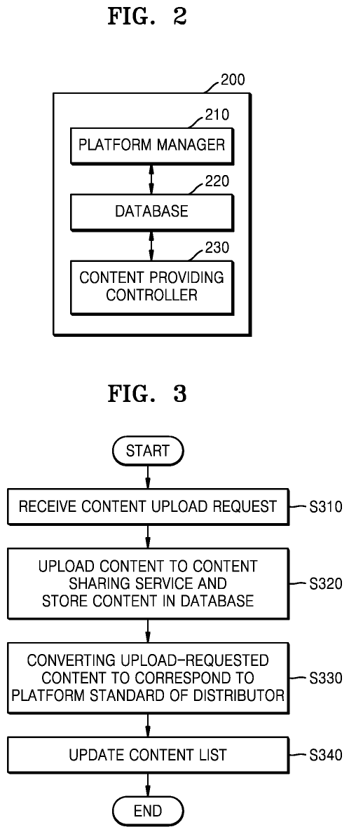

FIG. 2 is a block diagram for explaining components of the content management server 200 according to an embodiment of the present disclosure. Referring to FIG. 2, the content management server 200 may include a platform manager 210, a database 220, and a content providing controller 230.

The platform manager 210 according to an embodiment of the present disclosure is a configuration for generating and managing a platform for each distributor for providing content to the user terminal 100 and a content sharing service for an interface with the member company 300.

The platform manager 210 may receive metadata of various contents and match each content. The platform manager 210 may deliver the converted content to a distributor through a content delivery network (CDN) that is a distribution network, and may receive reproduction URL information from the distributor. In addition, the platform manager 210 may deliver the converted video to the distributor through the CDN, which is a distribution network, and may receive reproduction URL information from the distributor.

In addition, a content URL and/or metadata of an image may be transmitted from an information management control server (e.g., back office (BO)) to a platform of a distributor through an application type, for example, a cloud application. In addition, as another example, content data and/or metadata may be transmitted to the platform of the distributor via the content providing controller 230 through a cloud control connection unit to be described later.

The platform manager 210 may receive a request to upload content through the content sharing service. The request may be made by the member company 300. According to an embodiment of the present disclosure, the content may include content data and metadata corresponding thereto. In this case, the metadata may include a content name, PD (producer) information, MD (merchandiser) information, show host information, etc., but it is not limited thereto.

The platform manager 210 may store the content uploaded by the member company 300 in the database 220. According to an embodiment of the present disclosure, the platform manager 210 may convert the upload-requested content to correspond to a platform standard of a distributor accessed through a set-top box connected to the user terminal 100 according to settings, and then upload the content to the distributor platform.

The platform manager 210 may include one or more servers or NAS storages, may include one or more transcoders, and may generate a plurality of transformed copies to correspond to various platforms for one video. That is, the platform manager 210 may convert the content for one video to a plurality of converted contents (i.e., transformed copies) to correspond to various platform standards of distributors. The platform manager 210 may transmit each transformed video to the corresponding platform among the various platforms, for example, the broadcast server 400 such as each IPTV service provider, using a distributed network function such as a CDN of an IPTV service provider.

When content including content data and metadata is uploaded, the platform manager 210 may convert the metadata to correspond to the various platform standards of the distributors and match the converted metadata to corresponding converted content data. The platform manager 210 may convert the content according to the various platform standards of the distributors such as various broadcasting providers (e.g., IPTV service providers), encode the content, and generate and match various metadata sets corresponding to each encoded video information.

The platform manager 210 may transmit such converted video information, for example, encoded video on demand (VOD) to each set-top box for each distributor. For example, the platform manager 210 may deliver the encoded content to the set-top box as it is. The platform manager 210 may deliver the converted content to a distributor through a CDN, which is a distribution network, and may receive reproduction URL information from the distributor.

According to the present disclosure, by transmitting encoded content through a CDN, which is a distribution network, it is possible to achieve efficient delivery of an image.

The content sharing service may transmit a content URL and metadata from the platform manager 210 to a distributor through an application type, for example, a cloud application. The platform manager 210 may update a content list based on the uploaded content and metadata. In this case, the content list may be a list of a plurality of contents uploaded through a plurality of member companies (e.g., first member company to n^{th} member company). For example, the platform manager 210 may list information such as video code, content name, content length, registration status, distribution status, registration date, distribution date, etc. for each of a plurality of contents.

Meanwhile, when there is a user input for selecting the first GUI included in the content list through the content sharing service, the platform manager 210 may provide additional information corresponding to the first GUI to the member company 300 through the content sharing service. In addition, when there is a second GUI selection input included in the content list, the platform manager 210 may provide additional information corresponding to the second GUI to the user terminal 100 through the content sharing service.

In this case, the additional information included in the additional information list may include ratings, reviews, cumulative sales, cumulative number of views, purchase connection rate versus views, etc. for each content, a Producing Director (PD), a Merchandising Director (MD), and a show host, but the present disclosure is not limited thereto. In addition, according to an embodiment of the present disclosure, when a user input is received in the GUI of the list including the additional information, the platform manager 210 may perform each function (e.g., a sorting function) in response thereto.

The database 220 according to an embodiment of the present disclosure is a component for storing all types of data for executing the content management server 200. In particular, the database 220 may store content data and metadata uploaded through the content sharing service executed by the platform manager 210. In addition, the database 220 may store image information and applications for executing a main channel image and an application image displayed on the screen of the user terminal 100.

The content providing controller 230 according to an embodiment of the present disclosure may control to display content corresponding to a displayed channel of the user terminal 100 under the user's control. For example, when a user inputs a channel selection through a remote controller while watching TV, these selection inputs may be recognized through set-top boxes and networks, etc., and information on the content image may be transmitted to the set-top box connected to the user's TV so that the content image related to the channel corresponding to the selection input is displayed on the user's TV.

According to an embodiment of the present disclosure, when the user selects a channel, the content providing controller 230 transmits video information (e.g., video link information) and/or other various information or functions corresponding to the selected channel to the set-top box connected to the user terminal 100, and the set-top box uses such information to receive data on content such as video from the broadcaster server 400, so that contents from the broadcaster server 400 together with screen information provided from the content providing controller 230 may be displayed together on the user terminal 100 connected to the set-top box.

The content providing controller 230 may control to run an application including at least one area differentiated from the channel image, which is the content from the broadcaster server 400, in a set-top box, or to run the application in the user terminal 100 through the set-top box. Such an application may operate simultaneously when an image, which is content from the broadcaster server 400, is displayed on a TV. For example, the application may start running at the same time when an image set in a channel is displayed on the user terminal 100.

In addition, as an example, control of information such as images and videos displayed on the user terminal 100 may be performed through the content providing controller 230 until a channel set according to a user's selection input is changed. As a specific example, the content providing controller 230 may control the screen of the user terminal 100 through control of an application including a TV image through a signal connection with a set-top box (not shown) connected to the user terminal 100.

An application running in the user terminal 100 through the content providing controller 230 or in the set-top box connected to the user terminal 100 may include various image information, and for example, may include a list form in which a user's selection input and response are made. In addition, as one example, an application running in the user terminal 100 through the content providing controller 230 or in the set-top box connected to the user terminal 100 may control a display of a frame in the form of a fixed image on the TV in the form of an image for a certain period of time.

In addition, as one example, an application running in the user terminal 100 through the content providing controller 230 or running in the set-top box connected to the user terminal 100 may control one or more video information to be displayed on the screen, and as a specific example, may display the video information. Alternatively, when implementing such a video, the content providing controller 230 may control a position in which the video is to be implemented among the entire screen area, and as an additional example, may control the position to be implemented in a frame area displayed as an application on the user terminal 100 screen.

As an example of operation, when a signal for video implementation is received through the content providing controller 230, the user terminal 100 may select a video corresponding to the signal from stored video information or select address information of a video and display it on the screen of the user terminal 100 through the set-top box. In this case, the user terminal 100 may display the selected video information in the received location or frame area.

When a user selects an input area through an application running in the user terminal 100 or in the set-top box connected to the user terminal 100, for example, a menu bar or various selection buttons, until the set channel is changed according to the user's selection input, this is transmitted to the content providing controller 230 through the set-top box and the network. The content providing controller 230 may cause one or more videos corresponding to the user's selection to be implemented on a TV connected to the set-top box. For example, a plurality of videos may be sequentially implemented, or a video may be changed or a new video may be started or terminated according to a user's selection.

The video information may include various types of information and may include shopping information. For example, one shopping deal information may be included in one video information. Alternatively, such video information may include TV home shopping video information each including one item.

The user may easily check a plurality of video information, as a specific example, shopping deal information without changing a channel by selecting a channel on the screen of the user terminal 100, and may easily view information on home shopping channels.

While checking the image information transmitted through the broadcasting center through the screen of the user terminal 100, at the same time, the user may check the image information, for example, various information on home shopping information, through an application implemented on the screen of the user terminal 100. For example, data information corresponding to the image information may be displayed together with the image on the screen of the user terminal 100, thereby improving user convenience and ordering convenience. In addition, according to the user's operation while the user is checking the image information transmitted through the broadcasting center, for example, according to the user's direction control of the remote controller or input of various selection buttons, the content providing controller 230 may selectively display various video information that has already been produced, such as shopping deal video information, on the user terminal 100.

The content providing controller 230 may include a cloud control connection unit (not shown). The application running screen may be easily displayed on the screen of the user terminal 100 in a cloud method, for example, a cloud streaming method. For example, the content providing controller 230 may include a media cloud server, and through such a media cloud server, the application may be implemented on the TV 100 screen as needed. The degree of including the application, data, software, etc. necessary for driving the application in the user terminal 100 or the set-top box connected to the user terminal 100 may be reduced or not included.

In addition, when implementing an application using a cloud server, an application may be implemented by driving a preliminary cloud server and an application may be implemented by driving a main cloud server. When the user selects a channel and the image of the selected channel starts to be displayed on the user terminal 100, a spare cloud server operation may be used, and when there is an operation by a user, for example, moving the focus or cursor on the screen, or inputting a selection through a remote controller, driving the main cloud server may be used.

When an application is run by driving a spare cloud server, the same information may be displayed to a plurality of users accessing the channel. In this case, essential information corresponding to image information, for example, real-time information data corresponding to image information such as real-time sales number and broadcast progress rate, pop-up data information, banner information linked to video, and the like, may be expressed. A spare cloud server may have various types, and may take the form of Broadcasting Cloud Streaming (BCS).

In a case where there is a user manipulation or selection, while the main cloud server is driven, each information according to the manipulation of each user may be displayed. The main cloud server may have various types, and may have a form of interactive cloud streaming (ICS), and one user may correspond to each window (application) displayed on the cloud server.

By using these selected clouds, the efficiency of the cloud server is improved and the load on the cloud server is reduced, such that it is possible to smoothly run a complex application even when multiple users are using the cloud server through channel selection at the same time. In addition, the minimum cloud server is allocated to users who do not stay for a long time or change channels after selecting a channel so that cloud server management efficiency may be improved.

Further description of each embodiment will be described later with reference to the related drawings.

FIG. 3 is a flowchart illustrating a method of managing content by using a content sharing service through a content management server according to an embodiment of the present disclosure.

The content management server 200 of the present disclosure may receive a request from the member company 300 to upload content through a content sharing service (S310). In this case, the member company 300 may perform a content upload request using an account capable of logging in to a content sharing service issued from an operating entity of the content management server 200.

The content may include content data and metadata corresponding thereto. In this case, the metadata may include a content name, PD information, MD information, show host information, etc., but is not limited thereto.

The content management server 200 may upload the upload-requested content to the content sharing service and store it in the database 220 (S320). The content management server 200 may convert the upload-requested content to correspond to a platform standard of a distributor (S330) accessible through the set-top box connected to the user terminal 100 and then transmit the content to each distributor.

The content management server 200 may update a content list based on the uploaded content and metadata (S340). In this case, the content list may be a list of a plurality of contents uploaded through a plurality of member companies (e.g., the first member company to the n^{th} member company).

According to an embodiment of the present disclosure, when there is a UI selection input for the content list through a content sharing service, the content management server 200 may provide a list of additional information corresponding to the GUI to the member company 300 through the content sharing service. When there is a GUI selection input for the content list through the distributor platform, the content management server 200 may provide a list of additional information corresponding to the GUI to the user terminal 100 or a set-top box connected to the user terminal 100 through a platform of a distributor.

In this case, the additional information included in the additional information list may include ratings, reviews, cumulative sales, cumulative number of views, purchase connection rate versus views, etc. for each content, PD, MD, and show host, but is not limited thereto. In addition, according to an embodiment of the present disclosure, the content management server 200 may perform a sorting function for each item through the UI of the additional information list.

Details will be described with reference to the corresponding drawings.

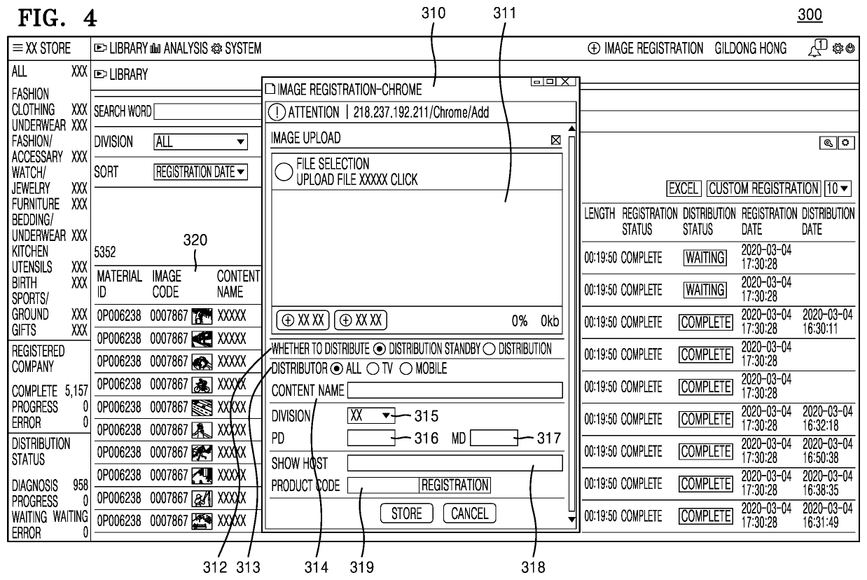

FIG. 4 is a diagram illustrating a content sharing service UI according to an embodiment of the present disclosure. FIG. 4 shows a screen in which the member company 300 logs in to the content sharing service through an account (Kil-dong Hong) issued by the operating entity of the content management server 200.

In the content sharing service according to an embodiment of the present disclosure, the UI 310 through which the member company 300 may upload contents stored in its own terminal device may be displayed on the terminal device of the member company 300. The UI 310 may include an upload GUI 311, a distribution status input GUI 312, a distributor input GUI 313, a content name input GUI 314, a classification input GUI 315, a PD input GUI 316, an MD input GUI 317, a show host input GUI 318, and a product code input GUI 319.

The distribution status input GUI 312 may be divided into a distribution standby GUI and a distribution GUI. The member company 300 may determine whether to directly upload the uploaded content through the distribution status input GUI 312. If the member company 300 selects the ‘distribution wait GUI’, the distribution of contents may be waited until the change selection is made to the ‘distribution GUI’.

The member company 300 may select a distributor through the distributor input GUI 313. The content sharing service may convert the uploaded content to correspond to the platform of the selected distributor through the distributor input GUI 313 and distribute the content to the platform of the selected distributor.

The content sharing service may receive the content name of the content requested to be uploaded through the content name input GUI 314, receive a classification (or category) of content through the classification input GUI 315, receive PD information of the corresponding content through the PD input GUI 316, receive MD information of the corresponding content through the MD input GUI 317, receive show host information of the corresponding content through the show host input GUI 318, and receive a product code for a product included in the corresponding content through the product code input GUI 319.

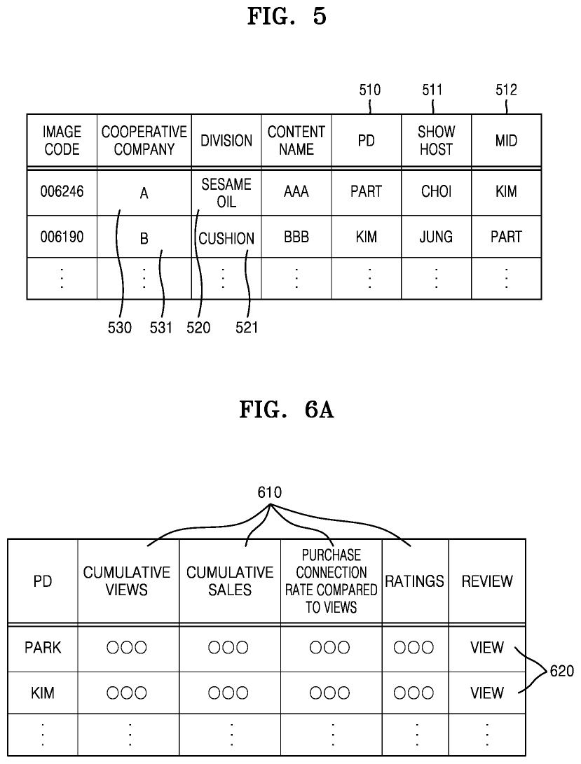

The content sharing service according to an embodiment of the present disclosure may include a content list 320 corresponding to a plurality of contents uploaded from a plurality of cooperative companies 300. This will be described in detail with reference to FIG. 5.

FIG. 5 is a diagram for a content list displayed on a content sharing service according to an embodiment of the present disclosure.

The content list 320 may list attribute information, such as image code, member company, classification, content name, PD, show host, MD information, etc. for a plurality of contents, respectively. However, this is only an example, and the content list 320 may further list status information such as content length, registration status, distribution status, registration date, and distribution date.

The content list 320 may include a PD selection GUI 510, a show host selection GUI 511, an MD selection GUI 512, division column GUIs 520 and 521, and a member company column GUIs 530 and 531. The content list 320 may be displayed on both the content sharing service and the platform of the distributor, respectively.

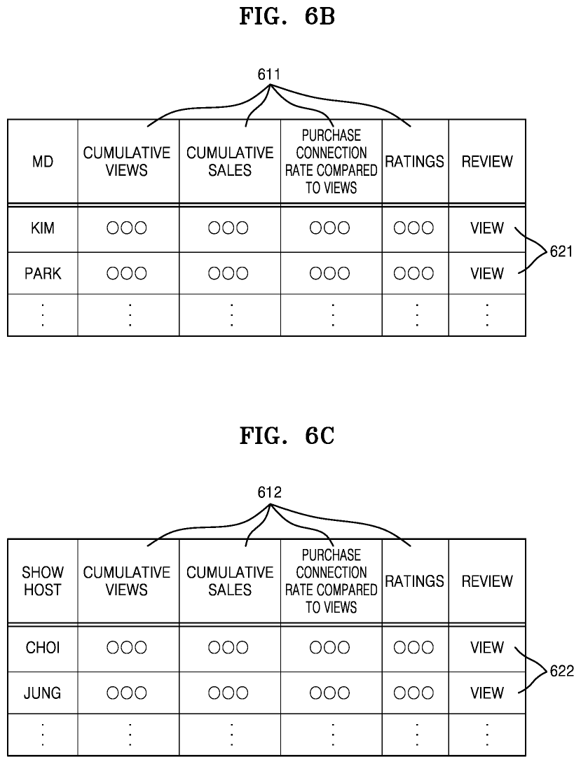

When there is an input to the PD selection GUI 510, the show host selection GUI 511, or the MD selection GUI 512 included in the content list through the content sharing service, the content management server 200 of the present disclosure may provide a first additional information list to the content sharing service. The first additional information list will be described in detail with reference to FIGS. 6A to 6C.

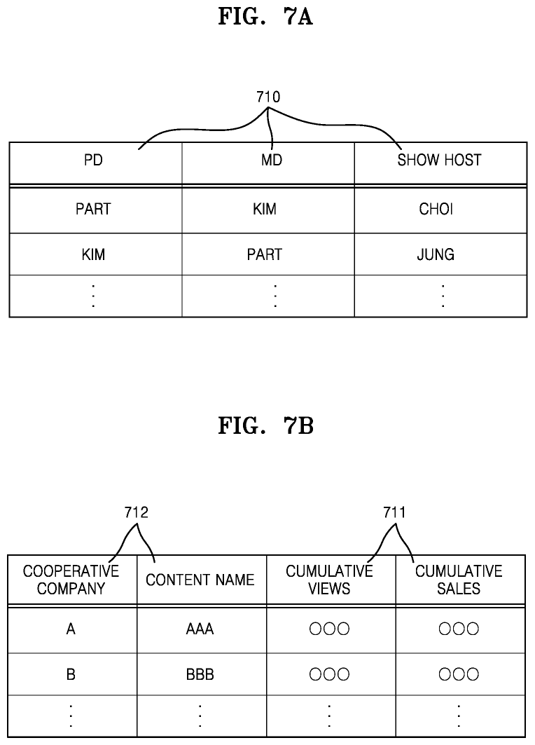

On the other hand, when there is an input to the division column GUIs 520 and 521 or the member company column GUIs 530 and 531 included in the content list through the content sharing service, the content management server 200 of the present disclosure may provide a second additional information list to the content sharing service. This will be described later with reference to FIGS. 7A and 7B.

FIGS. 6A to 6C are diagrams for explaining that additional information for each PD, MD, and show host is displayed on a member company account according to an embodiment of the present disclosure.

The content management server 200 may obtain additional information such as cumulative number of views, cumulative sales amount, purchase connection rate compared to number of views, ratings, reviews, etc. related to the content displayed in the user terminal 100. In this case, the content management server 200 may obtain the additional information by matching each element (e.g., PD, MD, show host) included in the metadata of each of the plurality of contents. The content management server 200 converts the additional information matched with each element into metadata in content data so that the information may be converted, saved and updated.

When a user command is input to the GUI included in the content list of FIG. 5 through the content sharing service, the content management server 200 may provide a first additional information list to a content sharing service in response to a user command based on the above-described metadata and content data.

Specifically, referring to FIG. 6A, when the PD selection GUI 510 is selected in the content sharing service, the content management server 200 may provide to the member company 300 a first additional information list including additional information including cumulative views, cumulative sales volume, purchase connection rate to views, ratings, reviews, etc. for each PD.

Referring to FIG. 6B, when the MD selection GUI 520 is selected in the content sharing service, the content management server 200 may provide to the member company 300 a first additional information list including additional information including cumulative views, cumulative sales volume, purchase connection rate to views, ratings, reviews, etc. for each MD.

Referring to FIG. 6C, when the show host selection GUI 530 is selected in the content sharing service, the content management server 200 may provide to the member company 300 a first additional information list including additional information including cumulative views, cumulative sales volume, purchase connection rate to views, ratings, reviews, etc. for each show host.

On the other hand, according to an embodiment of the present disclosure, when there is a user command for selecting the sorting GUIs 610, 611, and 612, the content management server 200 may perform a function corresponding to the user command (e.g., ascending order, descending order, etc.). If there is a user command to select the viewing GUIs 620, 621, and 622 from the member company 300, the content management server 200 may provide a review of the PD, MD, show host to the member company 300.

When each member company 300 logs in through an account issued from the operating entity of the content management server 200, the content management server 200 may provide a list of second additional information on content uploaded to a corresponding account for each member company 300.

FIGS. 7A and 7B are diagrams for explaining that additional information for each classification (or category) is displayed on a member company account and a user account, respectively.

The content management server 200 may provide a plurality of contents through a platform of a distributor such that the contents are displayed on the user terminals 100, and obtain additional information such as cumulative number of views, cumulative sales amount, purchase connection rate compared to number of views, ratings, reviews, etc. related to the contents displayed on the user terminals 100. In this case, the content management server 200 may obtain the additional information by matching each element (e.g., PD, MD, show host) included in the metadata of each of the plurality of contents. The content management server 200 converts the additional information matched with each element into metadata in content data so that the information may be converted and saved.

When a user command is input to the division column GUIs 520 and 521 or the member company column GUIs 530 and 531 included in the content list of FIG. 5 from the member company 300 through the content sharing service, the content management server 200 may provide a second additional information list to a content sharing service in response to a user command based on the above-described metadata and content data. In particular, when the division column GUIs 520 and 521 are selected by the member company 300, the content management server 200 may provide a second content list corresponding to the corresponding division column GUIs 520 and 521 to the member company 300, as shown in FIG. 7A. For example, when the member company 300 selects the sesame oil GUI 520, the content management server 200 may provide the member company 300 with a list of PDs, MDs, and show hosts related to sesame oil classification. At this time, if there is a user command for selecting each GUI 710, the content management server 200 may perform a function (e.g., sorting by cumulative number of views, sorting by cumulative sales volume, sorting by purchase connection rate compared to hits, sorting by rating, etc.) corresponding to a user command.

When the member company column GUIs 530 and 531 are selected by the user of the user terminal 100, as shown in FIG. 7B, the content management server 200 may provide a second content list corresponding to the member company column GUIs 530 and 531 to the user terminal 100 or a set-top box connected thereto. For example, when the sesame oil GUI 520 is selected by the user of the user terminal 100, the content management server 200 may provide a member company related to sesame oil classification, a content name, a cumulative number of views, and a list of cumulative sales amount to the member company 300.

At this time, if there is a user command for selecting each GUI 711, the content management server 200 may perform a function (e.g., sorting by cumulative number of views, sorting by cumulative sales volume, sorting by purchase connection rate compared to hits, sorting by rating, etc.) corresponding to a user command. In addition, when there is a user command for selecting each GUI 712, the content management server 200 may perform a function (e.g., ascending order, descending order, etc.) corresponding to the user command.

According to the present disclosure, as in the above-described embodiment, for the same GUI included in the same content list, the list to be provided may be different depending on whether a user logged in through an account issued from an operating entity of the content management server 200 selects a GUI or a general user selects a GUI. Accordingly, the content management server 200 provides additional information on the content uploaded to the platform only for a specific account, so that it has the effect of providing information providing services for contracted cooperative companies while maintaining security for sensitive information.

The device described above may be implemented as a hardware component, a software component, and/or a combination of a hardware component and a software component. For example, the devices and components described in the embodiments may be implemented using one or more general purpose computers or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and one or more software applications executed on the OS. In addition, the processing device may access, store, operate, process, and generate data in response to the execution of software. For the convenience of understanding, in some cases, one processing device is described as being used, but those of ordinary skill in the art will appreciate that the processing device may include a plurality of processing elements and/or multiple types of processing elements. For example, the processing device may include a plurality of processors or one processor and one controller. In addition, other processing configurations are possible, such as a parallel processor.

The software may include a computer program, code, instruction, or a combination of one or more of these, and may configure the processing device to operate as desired, or may command the processing device independently or collectively. In order to be interpreted by the processing device or to provide commands or data to the processing device, software and/or data may be permanently or temporarily embodied in any type of machine, component, physical device, virtual equipment, computer storage medium or device, or signal wave to be transmitted. The software may be distributed over networked computer systems and stored or executed in a distributed manner. Software and data may be stored on one or more computer-readable recording media.

The method according to the embodiment may be implemented in the form of program instructions that may be executed through various computer means and recorded in a computer-readable medium. The computer-readable medium may include program instructions, data files, data structures, etc. alone or in combination. The program instructions recorded in the medium may be specially designed and configured for embodiments, or may be known and usable to those skilled in computer software. Examples of computer-readable recording media include hardware devices specially configured to store and execute program instructions, for example, magnetic media such as hard disks, floppy disks and magnetic tapes, optical media such as CD-ROM and DVD, magneto-optical media such as a floptical disk, and ROM, RAM, flash memory, etc. Examples of the program instructions include not only machine language codes such as those produced by a compiler, but also high-level language codes that may be executed by a computer using an interpreter or the like. The above-described hardware device may be configured to operate as one or more software modules to perform the operation of an embodiment, and vice versa.

The platform system according to an embodiment of the present disclosure may provide various information to users through a distributed information processing load.

According to the platform system according to an embodiment of the present disclosure, for commerce contents serviced in video on demand (VOD) format, it enables customers to easily obtain information on products of commerce content being viewed.

Furthermore, it may increase the reliability with cooperative companies and realize service support suitable for various platforms.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A content sharing method comprising:
receiving an upload request of selected content from a registered member system;
converting, with a content management server having a database and a controller, the selected content to a first converted content to correspond to a first platform standard of a first distributor system;
uploading the first converted content to a content sharing service application;
converting, with the content management server, the selected content to a second converted content to correspond to a second platform standard of a second distributor system;
uploading the second converted content to the content sharing service application;
transmitting the first converted content to the first distributor system through the content sharing service application; and
transmitting the second converted content to the second distributor system through the content sharing service application.

2. The content sharing method of claim 1, further comprising updating a content list based on a set of data relevant to the content.

3. The content sharing method of claim 2, wherein converting the selected content further comprises:
generating metadata based on the set of data relevant to the content;
adding the metadata to the first and second converted contents; and
storing, in the database, the metadata-added first and second converted contents.

4. The content sharing method of claim 2, wherein the set of data relevant to the content comprises a content name, a content category, a PD (producer) name, a show host name, a product code, or a combination thereof.

5. The content sharing method of claim 2, further comprising:
when content included in the content list is displayed on a user terminal through the platform of the first distributor system or the second distributor system, receiving additional information corresponding to a display on the user terminal; and
updating the content list based on the additional information.

6. The content sharing method of claim 5, wherein the additional information comprises a cumulative number of views, a cumulative sales amount, a purchase connection rate compared to the number of views, a rating, a review from the user terminal, or a combination thereof.

7. A computer-readable recording medium on which a program for performing the method of claim 1 is recorded.

8. A content sharing method comprising:
receiving first content from a first registered member system;
transcoding, with a content management server having a database and a controller, the first content according to a first platform specific standard for use in a first broadcast server;
storing in the memory and uploading, transcoded first content using a content sharing service application;
generating a transformed copy of the transcoded first content, with the content management server, according to a second platform specific standard for use with a second broadcast server;
storing in the memory and uploading, the transformed copy of the transcoded first content using the content sharing service application;
transmitting the transcoded first content to the first broadcaster server through the content sharing service application; and
transmitting the transformed copy of the transcoded first content to the second broadcast server through the content sharing service application.

9. The content sharing method of claim 8, wherein transmitting the transcoded first content further comprises transmitting an URL of the transcoded first content to the first broadcast server.

10. The content sharing method of claim 8, further comprising transmitting the transformed copy to a set-top box communicatively coupled to the second broadcast server.

11. The content sharing method of claim 8, further comprising:
updating a content list based on a plurality of uploaded contents and correlated metadata, wherein the content list includes a list of the plurality of uploaded contents from a plurality of registered member systems.

12. The content sharing method of claim 11, further comprising:
upon receiving a first user input for selecting one of the content list through the content sharing service application, transmitting, with the content management server, first additional information corresponding to the first user input, to one of the broadcast servers associated with the selected list.

13. A content management platform system comprising:
a platform manager configured to:
receive an upload request of selected content from a registered member system;
convert the selected content to a first converted content to correspond to a first platform standard of a first distributor system;
convert the selected content to a second converted content to correspond to a second platform standard of a second distributor system;
upload the first converted content to a content sharing service application; and
upload the second converted content to the content sharing service application; and
a content providing controller configured to transmit the first converted content to the first distributor system and the second converted content to the second distributor system through the content sharing service application.

14. The content management platform system of claim 13, wherein the platform manager updates a content list based on a set of data related to the content.

15. The content management platform system of claim 14, wherein the platform manager is configured to:
generate metadata based on the set of data related to the content;
add and store the metadata to the selected content; and
convert the selected content to correspond to a platform standard of the distributor system.

16. The content management platform system of claim 14, wherein the data related to the content comprises a content name, a content category, a PD name, a show host name, a product code, or a combination thereof.

17. The content management platform system of claim 13, wherein, when content included in the contents list is displayed on a user terminal through the platform of the first distributor system or the second distributor system, the platform manager receives additional information corresponding to a display on the user terminal and updates the content list based on the additional information.

18. The content management platform system of claim 17, wherein the additional information comprises a cumulative number of views, a cumulative sales amount, a purchase connection rate compared to the number of views, a rating, a review from the user terminal, or a combination thereof.

19. The content management platform system of claim 17, wherein the content providing controller is further configured to control a display of a channel on a user terminal such that the content providing controller transmits, base information and functions in response to a channel selection on the user terminal, to a set-top box connected to the user terminal;
wherein first content according to the base information and functions is received from the first distributor system or the second distribution system and displayed on the user internal along with second content provided by the content providing controller.

20. The content management platform system of claim 13, further comprising:
a database configured to store:
contents and correlated metadata uploaded through the content sharing service application;
image information; and
applications for executing a main channel image upon selection of a channel at a user terminal communicatively connected to the content management platform system and an application image displayed on the user terminal.
